(19) United States
(12) Patent Application Publication
(10) Pub. No.: US 2024/0086492 A1
(43) Pub. Date: Mar. 14, 2024

(54) INFORMATION PROCESSING APPARATUS, INFORMATION PROCESSING METHOD, AND NON-TRANSITORY STORAGE MEDIUM

(71) Applicant: NEC Corporation, Minato-ku, Tokyo (JP)

(72) Inventors: Daniel Georg ANDRADE SILVA, Tokyo (JP); Yuzuru OKAJIMA, Tokyo (JP)

(73) Assignee: NEC Corporation, Minato-ku, Tokyo (JP)

(21) Appl. No.: 18/273,522

(22) PCT Filed: Jan. 21, 2021
(86) PCT No.: PCT/JP2021/002097

§ 371 Date: Jul. 20, 2023

(51) Int. Cl. G06F 17/18

(52) U.S. Cl. CPC G06F 17/18

(57) ABSTRACT

An information processing apparatus (100) is disclosed. The information processing apparatus (100) includes an input means (102), a statistic calculation means (104) and an optimization means (106). The input means (102) receives input samples including responses and covariates. The statistic calculation means (104) transforms the responses into transformed samples using a function depending on the covariates and an unbiased parameter. A distribution of the transformed samples only depends on a dispersion parameter. The optimization means (106) maximizes a distribution of the transformed samples to determine an estimate of the dispersion parameter.

### TECHNICAL FIELD

The present invention relates to an information processing apparatus, information processing method, control program, and non-transitory storage medium.

### BACKGROUND ART

Many real world data sets contain outliers, i.e. data points that are not representative of the majority of samples. For example, the output of a broken sensor might lead to an outlier observation. It is well known that estimating the parameters of a statistical model from data which contains outliers, can often lead to arbitrarily bad estimates.

### CITATION LIST

### Non Patent Literature

[NPL 1]

Rousseeuw, Peter J and Leroy, Annick M, “Robust regression and outlier detection”, 2005.

[NPL 2]

Blondel, Mathieu and Teboul, Olivier and Berthet, Quentin and Djolonga, Josip, “Fast Differentiable Sorting and Ranking”, In Proceedings of the International Conference on Machine Learning, 2020.

[NPL 3]

Rice and Spiegelhalter, “A simple diagnostic plot connecting robust estimation, outlier detection, and false discovery rates”, Journal of Applied Statistics, 2007.

[NPL 4]

DasGupta, Anirban, “Probability for statistics and machine learning: fundamentals and advanced topics”, 2011.

### SUMMARY OF INVENTION

### Technical Problem

An example aspect of the present invention is attained in view of the problem, and an example object is to provide a preferred technique for dispersion parameter estimation.

### Solution to Problem

In order to attain the object described above, an information processing apparatus comprising: an input means for receiving a plurality of input samples including a plurality of responses and a plurality of covariates; a statistic calculation means for transforming the responses into a plurality of transformed samples using a function depending on the covariates and an unbiased parameter so that a distribution of the transformed samples only depends on a dispersion parameter; and an optimization means for maximizing a distribution of the transformed samples to determine an estimate of the dispersion parameter.

In order to attain the object described above, an information processing apparatus comprising: an input means for receiving a plurality of input samples including a plurality of responses and a plurality of covariates; a statistic calculation means for transforming the responses into a plurality of transformed samples using a function depending on the covariates and an unbiased parameter so that a distribution of the transformed samples only depends on the dispersion parameter; an optimization means for maximizing the distribution of the transformed samples to determine an estimate of the dispersion parameter; a p-value calculation means for estimating p-values with reference to the estimate of the dispersion parameter; and an outlier decision means for determining a list of outliers with reference to the p-values.

In order to attain the object described above, an information processing method, comprising: receiving the input samples including a plurality of responses and a plurality of covariates; transforming the responses into a plurality of transformed samples using a function depending on the covariates and an unbiased parameter so that a distribution of the transformed samples only depends on the dispersion parameter; and optimizing a probability of observing the transformed samples to determine an estimate of the dispersion parameter.

In order to attain the object described above, an information processing method, comprising: receiving a plurality of input samples including a plurality of responses and a plurality of covariates; transforming the responses into a plurality of transformed samples using a function depending on the covariates and an unbiased parameter so that a distribution of the transformed samples only depends on the dispersion parameter; maximizing the distribution of the transformed samples to determine an estimate of the dispersion parameter; estimating p-values with reference to the estimate of the dispersion parameter; and determining a list of outliers with reference to the p-values.

In order to attain the object described above, a control program for causing a computer to function as a host of the information processing apparatus, the control program being configured to cause the information processing apparatus to function as the input means, the statistic calculation means and the optimization means.

In order to attain the object described above, a control program for causing a computer to function as a host of the information processing apparatus, the control program being configured to cause the information processing apparatus to function as the input means, the statistic calculation means, the optimization means, the p-value calculation means and the outlier decision means.

### Advantageous Effects of Invention

According to an example aspect of the present invention, it is possible to provide a preferred technique for dispersion parameter estimation.

### BRIEF DESCRIPTION OF DRAWINGS

FIG. 1 is a block diagram illustrating an information processing apparatus according to the first example embodiment.

FIG. 2 is a flow chart showing steps of a method implemented by the information processing apparatus according to the first example embodiment.

FIG. 3 is a graph showing the highest probability density function (pdf) of a true inlier distribution explained in the first example embodiment.

FIG. 4 is a graph showing the estimated inlier distribution explained in the first example embodiment.

FIG. 5 is a graph showing the inlier distribution estimated with a method implemented by the information processing apparatus according the first example embodiment.

FIG. 6 is a block diagram illustrating an information processing apparatus according to the second example embodiment.

FIG. 7 is a block diagram illustrating an information processing apparatus according to the third example embodiment.

FIG. 8 is a flow chart showing steps of a method implemented by the information processing apparatus according to the third example embodiment.

FIG. 9 is a block diagram illustrating an information processing apparatus according to the fourth example embodiment.

FIG. 10 is a conceptual block diagram illustrating a computer used as the information processing apparatus according to the example embodiments.

### DESCRIPTION OF EXAMPLE EMBODIMENTS

### Brief Explanation of Background Art

Many real world data sets contain outliers, i.e. data points that are not representative of the majority of samples. For example, the output of a broken sensor might lead to an outlier observation. It is well known that estimating the parameters of a statistical model from data which contains outliers, can often lead to arbitrarily bad estimates.

A compelling remedy is to use the trimmed likelihood for parameter estimation. In contrast to other robust estimation procedures like Huber-loss, its hyper-parameter, the minimum number of inliers m (i.e. samples that are not outliers), has a clear interpretation, and is thus relatively easy to specify. For example, a conservative estimate is to set m=n/2, where n is the total number of samples.

The trimmed likelihood approach jointly estimates the parameters θ and the set of inliers \hat{B}⊆{1, . . . , n} as follows:

$$\hat{θ} , \hat{B} : {arg max}_{θ , B} p ( θ ) + {\sum }_{i ∈ B} log f ( {y}_{i} \vert {x}_{i} , θ ) , \\ subject to \vert B \vert = m , \qquad ( 1 )$$

where f and p denote the likelihood and prior, [symbol] denotes the response, and x denotes the covariates.
   Robust parameter estimation by solving the above optimization problem has been proposed, for example, by Non-patent Literature 1 and 2, etc.

Based on the robust estimate of the parameters
\hat{θ},
   we can identify the additional outliers
(i.e. outliers contained in {1, . . . , n}\\hat{B})
   based on the samples in the tail of the learned distribution
f( [symbol] |x,\hat{θ})
   using, for example, the method proposed in Non-patent literature 3.

### Problem to be Solved by the Invention

The dispersion parameters learned with the trimmed likelihood approach (the optimization problem in Equation 1), are often under-estimated, which we describe in more detail in the following.

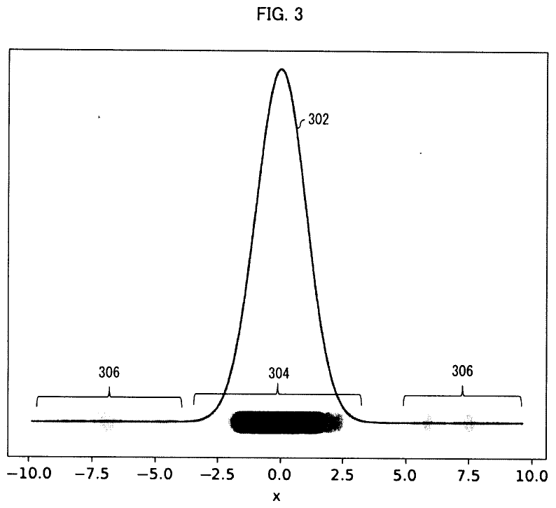

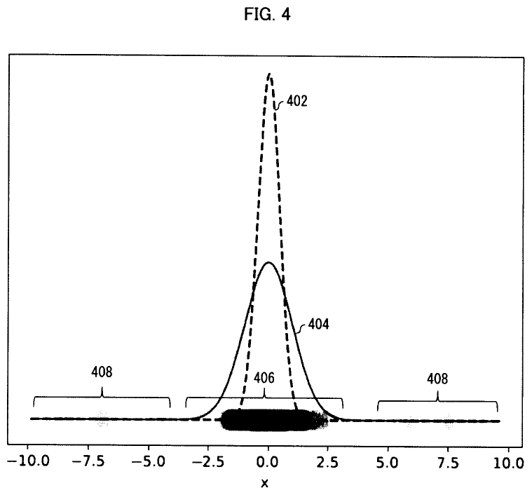

Let us assume that the statistical model has two parameters, it is characterized as
the mean μ and the variance σ², i.e. θ=(μ, σ²).
   Given enough data, the trimmed likelihood will be able to estimate the true mean μ correctly, though, the variance σ² will, in general, be underestimated. Consider the following example: assume 190 inlier samples being generated from a normal distribution with mean μ and variance 1, and 10 outlier samples from a symmetric distribution with support three standard deviations away from 0. The data, together with the inlier distribution, is shown in FIG. 3. Using the trimmed likelihood approach, with m=n/2, will considerably underestimate the variance as shown in FIG. 4. In case using the trimmed likelihood approach, with m=n/2, the inlier distribution is shown in FIG. 4. In FIG. 4, a dotted curve 402 shows the estimated inlier distribution based on the trimmed likelihood approach. Estimated inlier samples 406 and outlier samples 408 are shown in the bottom as dotted circles. The true inlier distribution 404 is shown in curve 404, and true inlier samples 406 are shown in the bottom of FIG. 4. As shown in FIG. 4, the estimated inlier distribution 402 has big difference from the true inlier distribution 404.

Note that this bias will not be remedied, even if the number of samples grows to infinity. The source of the problem is the gap between the true number of inliers, and the user specified lower bound m. However, it is necessary to set m to a conservative low value, since otherwise, we risk including an outlier, which can then lead to an arbitrarily bad estimate.

Finally, note that if we knew the true variance, or at least an upper bound, then we can estimate the outliers while controlling for the false discovery rate (FDR) using the method proposed in Non-patent literature 3. However, underestimating the variance will not allow us to control the FDR anymore.

### First Example Embodiment

### Information Processing Apparatus

The following description will discuss details of a first example embodiment according to the invention with reference to the drawings.

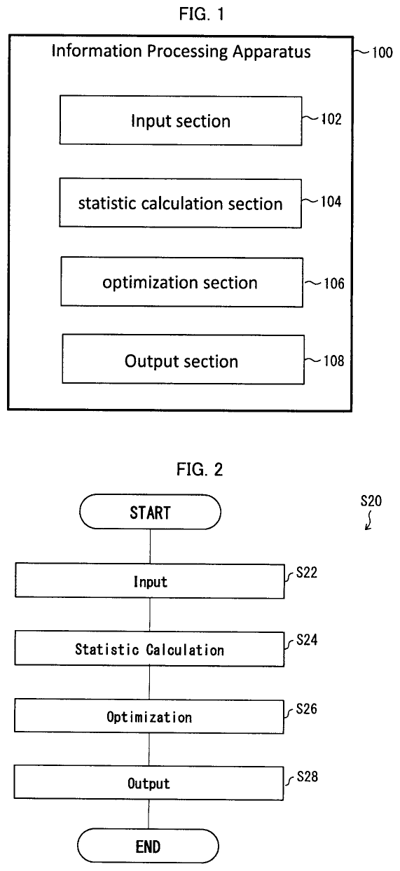

The first example embodiment relates to an information processing apparatus implementing a method for determining a dispersion parameter of a statistical model from data. FIG. 1 is a block diagram showing an information processing apparatus according to the first embodiment of the present invention. The information processing apparatus 100 includes an input section 102, a statistic calculation section 104, an optimization section 106 and an output section 108.

The input section 102 receives data or samples. The samples have outlier samples and inlier samples. The samples received by the input section 102 may be observed samples. The input section provides the received samples to the statistic calculation section 104 as input samples.

As a specific example, the observed samples received by the input section 102 have an inlier distribution as a curve line 302 in FIG. 3. The curve line 302 shows the highest probability density function (pdf) of the true inlier distribution. The observed samples includes inlier samples 304 and outlier samples 306 as shown in dotted circles in the bottom portion of FIG. 3.

As seen above, each of the observed samples has a covariate x and a response y. Therefore, the observed samples are represented as (xᵢ, yᵢ) where the index i indicates a sample index. In other words, a sample i contains a covariate xᵢ and its corresponding response yᵢ.

Note that covariates xᵢ may also be referred to as independent variables, predictors, features, or explanatory variables. Note also that the response yᵢ may also be referred to as dependent variables, outcome variables, or objective variables.

The statistic calculation section 104 receives the input samples from the input section 102. As explained above, the input samples include covariates and responses. The statistic calculation section 104 transforms the responses into transformed samples using a function depending on the covariates and an unbiased parameter. A distribution of the transformed samples only depends on a dispersion parameter.

Although a specific form of the function does not limit the first example embodiment, the function may include a linear term of the response yᵢ and a linear term of another function h which depends on an unbiased parameter.

The optimization section 106 receives the transformed samples from the statistic calculation section 104. The optimization section 106 maximizes the distribution of the transformed samples to determine an estimate of the dispersion parameter.

Although a specific method of maximizing the distribution may not limit the first example embodiment, the maximizing method may utilize a Markov property of the distribution and a maximum likelihood method.

### Information Processing Method

FIG. 2 is a flow chart showing steps of a method implemented by the information processing apparatus according to the first embodiment. The method S20 has 4 steps.

First, the input samples are input into the input section 102 (step S22). As described above, the input samples have responses and covariates. The samples received by the input section 102 may be observed samples. The input section 102 provides the received samples to the statistic calculation section 104 as input samples.

Then, the responses in the input samples are statistically calculated by the statistic calculation section 104 to be transformed into the transformed samples (step S24). During the calculation, a function depending on the covariates and an unbiased parameter is used. A distribution of the transformed samples only depends on a dispersion parameter.

The optimization section 106 optimizes a distribution of the transformed samples to determine an estimate of the dispersion parameter (step S26).

Finally, the estimate of the dispersion parameter is output (step S28).

### Advantageous Effect of the First Example Embodiment

According to the information processing apparatus 100 and the information processing method S20 of the first example embodiment, it is possible to get an accurate estimate of the inlier distribution, and thus enables to accurately detect outliers in the data. Accurate outlier detection is crucial for example to spot malicious activities from process log data, or to identify defective products from sensor data.

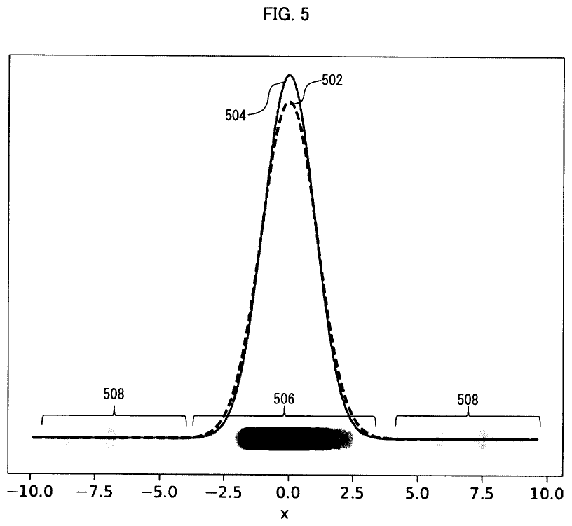

As shown in FIG. 5, the estimated inlier distribution according to the second example embodiment shown in dotted line 502 is close to the true inlier distribution shown in line 504.

### The Second Example Embodiment

The following description will discuss details of a second example embodiment of the invention with reference to the drawings. Note that the same reference numerals are given to elements having the same functions as those described in the first example embodiment, and descriptions of such elements are omitted as appropriate. Moreover, an overview of the second example embodiment is the same as the overview of the first example embodiment, and is thus not described here.

### Information Processing Apparatus

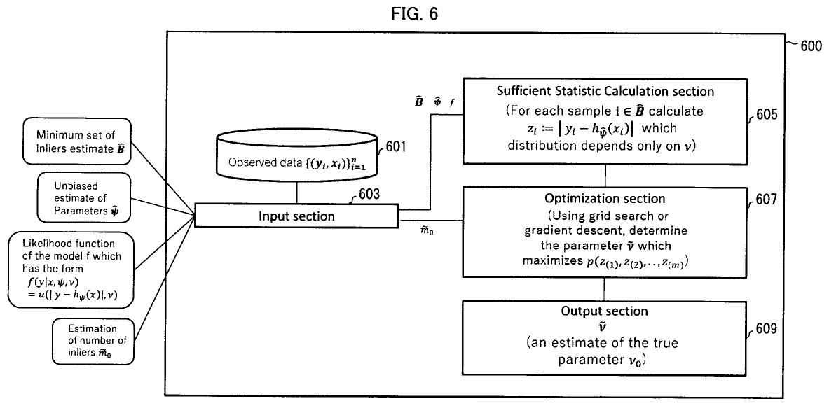

FIG. 6 shows a block diagram illustrating an information processing apparatus according to the second example embodiment. The information processing apparatus 600 includes a data base 601, an input section 603, a sufficient statistic calculation section 605, an optimization section 607, and an output section 609.

In the data base 601, the observed data (input data) are stored. The input data are transferred to the Input section 603. As described above, the input samples have responses and covariates. The input section 603 also receives a minimum set of inliers estimate
\hat{B}
   unbiased estimate of parameters
\hat{ψ}
   likelihood function of the model f which has the form

f(y|x,ψ,ν)=u(|y−h₁₀₄ (x)|,ν)

estimation of number of inliers
\tilde{m}₀

Note that the h in the likelihood function f represents a function which only depends on the unbiased parameter
ψ

The sufficient statistic calculation section 605 receives the minimum set of inliers estimate
\hat{B}
   unbiased estimate of parameters
\hat{ψ}
   likelihood function of the model f which has the form

f(y|x,ψ,ν)=u(|y−h₁₀₄(x)|,ν)

from the input section 603. The sufficient statistic calculation section 605 transforms the responses into transformed samples zᵢ using a function depending on the covariates and an unbiased parameter
ψ

A distribution of the transformed samples zᵢ only depends on a dispersion parameter
ν

As mentioned above, the sufficient statistic calculation section 605 transforms the responses yᵢ into transformed samples zᵢ using a function depending on the covariates and an unbiased parameter. A distribution of the transformed samples zᵢ only depends on a dispersion parameter.

More specifically, the sufficient statistic calculation section 605 carries out the following process.

(For each sample i∈\hat{B} calculate zᵢ=|yᵢ−h_{\hat{ψ}}(xᵢ)| which distribution depends only on ν)

The optimization section 607 receives estimation of number of inliers
\tilde{m}₀
   from the input section 603. Also, the optimization section 607 receives the distribution of the transformed samples from the sufficient statistic calculation section 605. The optimization section 607 maximizes the distribution of the transformed samples to determine an estimate of the dispersion parameter
\tilde{ν}

More specifically, the optimization section 607 carries out the following process,

(Using grid search or gradient descent, determine the parameter \tilde{ν} which maximizes p(z₍₁₎,z₍₂₎, . . . , z₍ₘ₎)

Finally, the output section 609 output the estimate of the dispersion parameter
\tilde{ν}
   which is an estimate of the true parameter
ν₀

The above operations and processes carried out by the input section 603, the sufficient statistic calculation section 605, the optimization section 607, and the output section 609 can be explained using the mathematical symbols and formula as follows.

First, let

θ=(ψ,ν)

where
ψ
   is the parameter (vector) which is assumed to be not affected by the selection bias, i.e. we assume

\hat{ψ}→ψ₀, for n→∞, where ψ₀

is the true parameter. Furthermore,
ν
   denotes the dispersion parameter which is affected selection bias of the trimmed likelihood.
   Let us recall that the trimmed likelihood finds the minimal set of inliers
\hat{B}⊆{1, . . . , n}, and estimates of ψ and ν:

$$\hat{ψ} , \hat{v} , \hat{B} := {arg max}_{θ , B} p ( θ ) + {\sum }_{i ∈ B} log f ( {y}_{i} \vert {x}_{i} , θ ) , \\ subject to \vert B \vert = m ,$$

where f and p denote the likelihood function and a prior distribution.

The proposed method assumes that
\hat{ψ}
   is unbiased estimate of
ψ₀.
   Our proposed method finds estimate of
ν
   which will, in general, have a lower bias than
\hat{ν}.

The second example embodiment includes two main sections “Sufficient Statistic Calculation section” and “Optimization section” as illustrated in FIG. 6, and described as follows.

### Sufficient Statistic Calculation Section

The processes carried out by the Sufficient Statistic Calculation section 605 can be described as follows.

We assume that the likelihood can be written in the following form

f( [symbol] ᵢ|xᵢψ,ν)=u(| [symbol] −h₁₀₄(x)|,ν), (2)

for some function u which depend only on

| [symbol] −h₁₀₄(x)| and ν,

and some function
h_{ψ} which only depends on parameter ψ.
   Furthermore, we define

[symbol]

:=| [symbol] −h₁₀₄(x)|.

As a consequence, we have that, for inliers, z is distributed according to a density
g_{ν}
   which only depends on

ν, i.e. [symbol] ˜ [symbol] _{ν}.

Finally, we assume that

f( [symbol] |x,ψ,ν)

is a strictly decreasing function in z, independent of
ν.
   Formally, let us define

fᵢ:=f( [symbol] ᵢ|xᵢ,ψ,ν), (3)

and

[symbol]

ᵢ:=| [symbol] ᵢ−h₁₀₄(xᵢ)|,

which may be calculated by the Sufficient Statistic Calculation section 605.

Then we have, for any

i,j∈{1, . . . , n},

that

[symbol]

ᵢ<zⱼ⇒fᵢ>fⱼ.

Furthermore, let us define by (1), (2), . . . , (n), the indices of the data points such that

f₍₁₎≥f₍₂₎≥f₍₃₎ . . . ≥f₍ₙ₎,

Then we have that

[symbol]

₍₁₎≤ [symbol] ₍₂₎ [symbol] ₍₃₎ . . . ≤ [symbol] ₍ₙ₎.

In particular, the m data points in
\hat{B}
   correspond to the m data points out of n, for which fᵢ is highest and thus zᵢ is lowest.

Let us denote by m₀, the true number of inliers. Note that by assumption that m is a lower bound on the number of inliers we have that

n≥m₀≥m.

Furthermore, assuming that outliers only occur in the tail of the inlier distribution, we have that the data points with indices (1), (2), . . . , (m₀) are all inliers. Therefore, we have

$$p ( {𝓏}_{( 1 )} , {𝓏}_{( 2 )} , {𝓏}_{( 3 )} … , {𝓏}_{( {m}_{0} )} ) = {\prod }_{𝒾 = 1}^{{m}_{0}} {g}_{𝓋} ( {𝓏}_{( 𝒾 )} ) . \qquad ( 4 )$$

Since
ψ
   is unknown, we may replace it with the unbiased estimate
\hat{ψ}.
   In other words, the sufficient statistic calculation section 605 uses an unbiased estimate
\hat{ψ}
   as the unbiased parameter
ψ

Alternatively, if a posterior distribution

p(ψ|y,X)

(where y, X denotes all training data) is given, we can integrate out
ψ.
   For example, instead of Equation (3), we may define

fᵢ:=∫f( [symbol] ᵢ|xᵢ,ψ,ν)p(ψ|y,X)dψ.

In order to obtain the above likelihood function fᵢ, the sufficient statistic calculation section 605 may carry out the above integration over the posterior distribution of
104 .

### Optimization Section

The processes carried out by the Optimization section 607 can be described as follows.

Next, we determine the distribution of

p( [symbol] ₍₁₎, [symbol] ₍₂₎, [symbol] ₍₃₎ . . . , [symbol] ₍ₘ₎).

First, note that for m₀>m, this density does not simply factorize as in Equation (4). This is due to the fact, that the samples in B, were not selected independently, but selected to be the m samples with the highest likelihood among the m₀ samples. Nevertheless, it is possible to determine the joint density of

p( [symbol] ₍₁₎, [symbol] ₍₂₎, [symbol] ₍₃₎ . . . , [symbol] ₍ₘ₎)

by using the tools of order statistics.

Since Z is a continuous random variable, we have that almost surely all data points have distinct values, and as a consequence the order statistics have the Markov property, i.e.

p( [symbol] ₍₁₊₁₎| [symbol] ₍ᵢ₎, [symbol] ₍ᵢ₋₁₎, . . . , [symbol] ₍₁₎)=p( [symbol] ₍ᵢ₊₁₎| [symbol] ₍ᵢ₎),

Therefore, we have

$$p ( {𝓏}_{( 1 )} , {𝓏}_{( 2 )} , … , {𝓏}_{( m )} ) = p ( {𝓏}_{( 1 )} ) {\prod }_{i = 1}^{m - 1} p ( {𝓏}_{( i + 1 )} \vert {𝓏}_{( i )} ) . \qquad ( Eq . A 1 )$$

The terms on the left hand side can be calculated using known results from order statistics, see e.g. Non-patent literature 4:

$$p ( {𝓏}_{( i )} ) = \frac{{m}_{0} !}{( i - 1 ) ! ( {m}_{0} - i ) !} {{G}_{𝓋} ( {𝓏}_{( i )} )}^{i - 1} {( 1 - {G}_{𝓋} ( {𝓏}_{( i )} ) )}^{n - i} {g}_{𝓋} ( {𝓏}_{( i )} ) , \qquad ( 5 )$$

$$and$$

$$p ( {𝓏}_{( i )} , {𝓏}_{( i + 1 )} ) = \frac{{m}_{0} !}{( i - 1 ) ! ( {m}_{0} - i - 1 ) !} {{G}_{𝓋} ( {𝓏}_{( i )} )}^{i - 1} {( 1 - {G}_{𝓋} ( {𝓏}_{( i + 1 )} ) )}^{{m}_{0} - i - 1} {g}_{𝓋} ( {𝓏}_{( i )} ) {g}_{𝓋} ( {𝓏}_{( i + 1 )} ) . \qquad ( 6 )$$

where G_{ν} and [symbol] _{ν} is the cdf and pdf of [symbol] , respectively.
   Finally, for Equations (5) and (6), it is often desirable to have an estimate
\tilde{m}₀
   of m₀ such that the resulting estimate of
ν,
   leads to estimates of p-values that never underestimate the true p-values. In most situations, this will be achieved by setting
\tilde{m}₀
   to n.

In order to make it explicitly that

p( [symbol] ₍₁₎, [symbol] ₍₂₎, . . . , [symbol] ₍ₘ₎)

depends only on
ν,
   we may write

p( [symbol] ₍₁₎, [symbol] ₍₂₎, . . . , [symbol] ₍ₘ₎)|ν)

Finally, the optimization section 607 carries out the maximum likelihood (ML) method to get an estimate of the true parameter
ν₀:

$$\tilde{v} := {arg max}_{𝓋} log p ( {𝓏}_{( 1 )} , {𝓏}_{( 2 )} , … , {𝓏}_{( m )} \vert 𝓋 ) .$$

Note that, in another example, instead of using one estimate
\tilde{m}₀
   for the true number of inliers
m₀,
   the optimization section 607 may use several possible estimates of
m₀,
   and then determines the final estimates of
ν
   using a weighted average where the weights are determined using a prior distribution
p(m₀).

In other words, the optimization section 607 may determine the estimate of the dispersion parameter
ν
   based on a weighted average of dispersion parameters, each of which is based on a respective estimate of the number of inliers.

### Example Linear Regression

In the following, we provide a more specific example of operations and processes carried out by the input section 603, the sufficient statistic calculation section 605, the optimization section 607, and the output section 609.

Let us assume the standard linear regression model with regression coefficient vector β and variance σ². The density of the response is defined as

$$f ( y \vert x , β , σ ) = \frac{1}{\sqrt{2 π {σ}^{2}}} {e}^{- \frac{1}{2 {σ}^{2}} {( y - {β}^{T} x )}^{2}} .$$

Clearly, the density is of the form as defined in Equation (2), with
\tilde{β}
   corresponding to
\hat{ψ}, and \hat{σ}² corresponding to \hat{ν}.
   Furthermore, note that

h_{ψ}(x)=β^{T}x

The output of the trimmed likelihood method will provide us with estimates
\hat{β}
   and
\hat{σ}².

Next we define,

[symbol]

:=| [symbol] −β^{T}i x|,
The cdf G_{σ} and pdf [symbol] _{σ} of [symbol] is given as follows

$${G}_{σ} ( 𝓏 ) := P ( Z \leq 𝓏 ) = 2 {\int }_{0}^{𝓏} f ( y = t \vert μ = 0 , σ ) dt , \\ {g}_{σ} ( 𝓏 ) := \frac{\partial }{\partial 𝓏} P ( Z \leq 𝓏 ) = 2 f ( y = 𝓏 \vert μ = 0 , σ ) ,$$

where f( [symbol] =t|μ=0, σ) is the normal distribution with. mean 0, and variance σ².
   We then proceed using Equation (5) and Equation (6) to determine the distribution of

p( [symbol] ₍₁₎, [symbol] ₍₂₎, . . . , [symbol] ₍ₘ₎|ν)

and optimize it with respect to σ. The determining process of the above distribution may be carried out by using the Eq. A1.

For the optimization, the optimization section 607 may either use gradient descent, or just grid search, since this is a one-dimensional optimization problem.

If we apply these results to the example data described in Section <Problems to be Solved by the Invention>, with

\tilde{m}₀=n

(which reflects our belief that there may be only few or no outliers) we find that the estimated variance
\tilde{σ}²
   matches well with the true variance
σ₀²,
   as shown in FIG. 5. (note that in this example, there are no covariates so β=0).

Finally, we show how to take into account the uncertainty of β. Let us assume that β is distributed according to a Normal distribution

p(β|μ,Σ),

we then have

$$\begin{matrix}p ( y \vert x , {σ}^{2} ) = \int f ( y \vert x , β , {σ}^{2} ) p ( β \vert μ , \sum ) d β \\ ∝ \int {e}^{- \frac{1}{2 {σ}^{2}} {( y - {x}^{T} β )}^{2}} \cdot {e}^{- \frac{1}{2} {( β - μ )}^{T} {\sum }^{- 1} ( β - μ )} d β \\ ∝ {e}^{- \frac{1}{2 {σ}^{2}} {y}^{2}} \int {e}^{- \frac{1}{2 {σ}^{2}} ( 2 - {yx}^{T} β + {β}^{T} {xx}^{T} β + {β}^{T} {σ}^{2} {\sum }^{- 1} β - 2 {β}^{T} {σ}^{2} {\sum }^{- 1} μ )} d β \\ ∝ {e}^{- \frac{1}{2 {σ}^{2}} ( {y}^{2} - {a}^{T} Da )} \\ ∝ {e}^{- \frac{1}{2 {σ}^{2}} ( {y}^{2} - {y}^{2} {x}^{T} {D}^{- 1} x - 2 {yx}^{T} {D}^{- 1} {σ}^{2} {\sum }^{- 1} μ )} \\ = {e}^{- \frac{α}{2 {σ}^{2}} {( y - z )}^{2}} \\ ∝ N ( 𝓏 , \frac{{σ}^{2}}{α} )\end{matrix} ,$$

where we defined D:=(xx^{T}+σ²Σ⁻¹), and a^{T}:=( [symbol] x^{T}+μ^{T}σ²Σ⁻¹)D⁻¹, and α:=1−x^{T}D⁻¹x, and

$$𝓏 := \frac{1}{α} {x}^{T} {D}^{- 1} {σ}^{2} {\sum }^{- 1} μ .$$

Using the Sherman-Morrison formula, we can simplify α as follows

$$\begin{matrix}α = 1 - {x}^{T} {D}^{- 1} x \\ = 1 - \frac{{x}^{T} {σ}^{- 2} \sum x}{1 + {x}^{T} {σ}^{- 2} \sum x} \\ = \frac{1}{1 + {x}^{T} {σ}^{- 2} \sum x}\end{matrix} .$$

And therefore, the variance of y is given by

var[ [symbol] ]=σ²+x^{T}Σx.

### Advantageous Effect of the Second Example Embodiment

According to the information processing apparatus 100 and the information processing method S20 of the second example embodiment, it is possible to get an accurate estimate of the inlier distribution, and thus enables to accurately detect outliers in the data. Accurate outlier detection is crucial for example to spot malicious activities from process log data, or to identify defective products from sensor data.

As shown in FIG. 5, the estimated inlier distribution according to the second example embodiment shown in dotted line 502 is close to the true inlier distribution shown in line 504.

### The Third Example Embodiment

The following description will discuss details of a third example embodiment of the invention with reference to the drawings. Note that the same reference numerals are given to elements having the same functions as those described in the first example embodiment, and descriptions of such elements are omitted as appropriate. Moreover, an overview of the third example embodiment is the same as the overview of the first example embodiment, and is thus not described here.

### Information Processing Apparatus

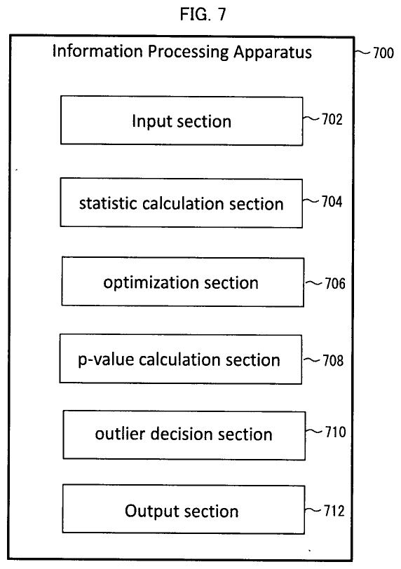

The third example embodiment relates to an information processing apparatus implementing a method for determining a dispersion parameter of a statistical model from data. FIG. 7 is a block diagram showing an information processing apparatus according to the third embodiment of the present invention. The information processing apparatus 700 includes an input section 702, a statistic calculation section 704, an optimization section 706, a p-value calculation section 710 and an output section 712.

The input section 702 receives data or samples. The samples have outlier samples and inlier samples. The samples received by the input section 102 may be observed samples. The input section provides the received samples to the statistic calculation section 104 as input samples. Since the input section 702 carries out same processes as the input section 102 of the first example embodiment, we omit further explanations of the input section 702.

The statistic calculation section 704 receives the input samples from the input section 702. As explained above, the input samples include covariates and responses. The statistic calculation section 704 transforms the responses into transformed samples using a function depending on the covariates and an unbiased parameter. A distribution of the transformed samples only depends on a dispersion parameter. Since the statistic calculation section 704 carries our same processes as the statistic calculation section 104 of the first example embodiment, we omit further explanations of the statistic calculation section 704.

The optimization section 706 receives the transformed samples from the statistic calculation section 704. The optimization section 706 maximizes the distribution of the transformed samples to determine an estimate of the dispersion parameter. Since the optimization section 706 carries our same processes as the optimization section 106 of the first example embodiment, we omit further explanations of the optimization section 706.

The p-value calculation section 708 receives one or more estimates of the dispersion parameter from the optimization section 706. The p-value calculation section 708 estimates one or more p-values with reference to the estimate of the dispersion parameter.

Although a specific example of calculation processes carried out by the p-value calculation section 708 does not limit the third example embodiment, the p-value calculation section 708 may carry out the above calculation under null hypotheses.

The outlier decision section determines a list of outliers with reference to the p-values.

Although a specific example of determining processes carried out by the outlier decision section 710 does not limit the third example embodiment, the outlier decision section 710 may carry out the above determination with reference to a conservative estimate of the p-value for each sample.

The output section 712 outputs the list of outliers.

### Information Processing Method

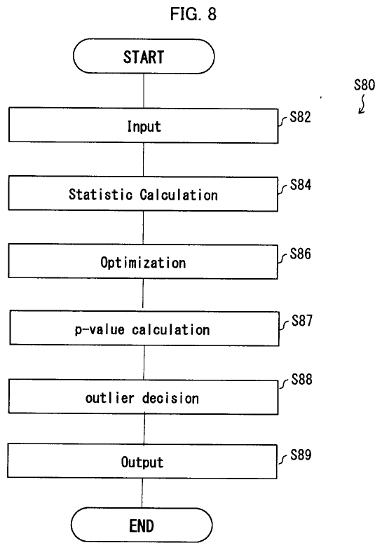

FIG. 8 is a flow chart showing steps of a method implemented by the information processing apparatus according to the third example embodiment. The method S20 has 6 steps.

First, the input samples are input into the input section 802 (step S82). As described above, the input samples have responses and covariates.

Then the responses in the input samples are calculated statistically to be transformed into the transformed samples (step S84). During the calculation, a function depending on the covariates and an unbiased parameter is used. A distribution of the transformed samples only depends on a dispersion parameter.

The distribution of the transformed samples is maximized to determine an estimate of the dispersion parameter (step S86).

Next, the p-values are estimated with reference to the estimate of the dispersion parameter (step S87).

Then, a list of outliers with reference to the p-values is determined with reference to the p-values.

Finally, the list of outliers is outputted (step S89).

### Advantageous Effect of the Third Example Embodiment

According to the information processing apparatus 700 and the information processing method S80 of the third example embodiment, it is possible to get an accurate estimate of the inlier distribution, and thus enables to accurately detect outliers in the data. Accurate outlier detection is crucial for example to spot malicious activities from process log data, or to identify defective products from sensor data.

As shown in FIG. 5, the estimated inlier distribution according to the second example embodiment shown in dotted line 502 is close to the true inlier distribution shown in line 504.

### The Fourth Example Embodiment

The following description will discuss details of a fourth example embodiment of the invention with reference to the drawings. Note that the same reference numerals are given to elements having the same functions as those described in the first example embodiment, and descriptions of such elements are omitted as appropriate. Moreover, an overview of the fourth example embodiment is the same as the overview of the second example embodiment, and is thus not described here.

### Information Processing Apparatus

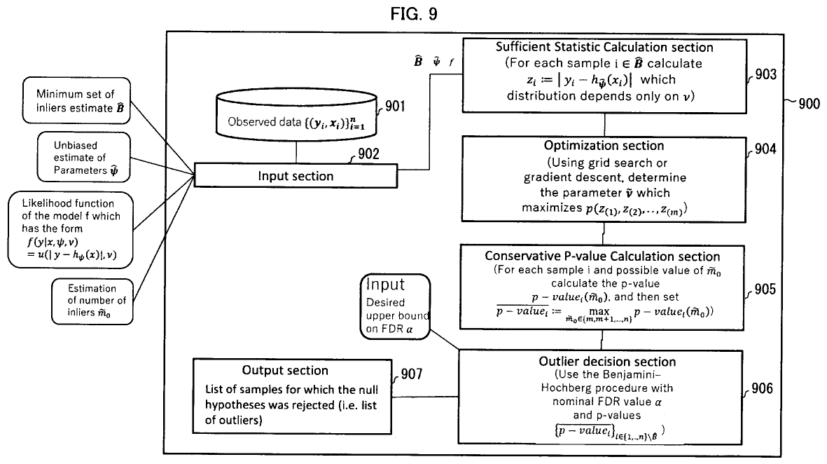

FIG. 9 shows a block diagram illustrating an information processing apparatus according to the fourth example embodiment. The information processing apparatus 900 includes a data base 901, an input section 902, a sufficient statistic calculation section 903, an optimization section 904, a conservative p-value calculation section 905, outlier decision section 906 and an output section 907.

In the data base 901, the observed data (input data) are stored. The input data are transferred to the input section 902. As described above, the input samples have responses and covariates.

Since the input section 902 carries out same processes as the input section 603 of the second embodiment, we omit further explanation of the input section 902.

The sufficient statistic calculation section 903 transforms the responses into transformed samples using a function depending on the covariates and an unbiased parameter
ψ

A distribution of the transformed samples only depends on a dispersion parameter
ν

Since the sufficient statistic calculation section 903 carries out same processes as the sufficient statistic calculation section 605 of the second example embodiment, we omit further explanation of the sufficient statistic calculation section 903.

The optimization section 904 receives the distribution of the transformed samples from the sufficient statistic calculation section 903. The optimization section 904 maximizes the distribution of the transformed samples to determine an estimate of the dispersion parameter
\tilde{ν}

Since the optimization section 904 carries out same processes as the optimization section 607 of the second example embodiment, we omit further explanation of the optimization section 904.

The conservative p-value calculation section 905 receives one or more estimates of the dispersion parameter. The p-value calculation section 905 estimates a p-value with reference to estimate of the dispersion parameter. More specifically, the conservative p-value calculation section 905 may carry out the following process.

$$( For each sample i and possible value of {\tilde{m}}_{0} \\ calculate the p - value \\ p - {value}_{i} ( {\tilde{m}}_{0} ) , and then set \\ \overline{p - {value}_{i}} := {max}_{{\tilde{m}}_{0} ∈ \{ m , m + 1 , … , n \}} p - {value}_{i} ( {\tilde{m}}_{0} ) )$$

The outlier decision section 906 receives the estimate of the p-value from the conservative p-value calculation section 905. The outlier decision section 906 determines a list of outliers with reference to the p-value. More specifically, the outlier decision section 906 may carry out the following process.

$$( Use the Benjamini - Hochberg procedure with nominal \\ FDR value α and p - values {\{ \overline{p - {value}_{i}} \}}_{i ∈ \{ 1 , … , n \} \backslash \hat{B}} )$$

Finally, the output section 907 output the list of outliers (samples for which the null hypotheses was rejected).

The above operation is explained using the mathematical symbols and formula. As to the data base 901, the input section 902 and the sufficient statistic calculation section 903 are same to the data base 601, the input section 603 and the sufficient statistic calculation section 605 of the second example embodiment, the detailed explanation is omitted. Further, the optimization section 904 has the same function of the optimization section 607 of the second example embodiment. Since the different point is whether the optimization section (607, 904) receives the estimation of number of inliers
\tilde{m}₀
   from the input section 902, the detailed explanation is also omitted.

The forth example embodiment includes two main sections “Conservative P-value Calculation section” 905 and “Outlier decision section” 906 in addition to the information processing apparatus 600 of second example embodiments. Therefore, the above “Conservative P-value Calculation section” 905 and “Outlier decision section” 906 are described in detail.

### Conservative P-Value Calculation Section

The processes carried out by the Conservative P-value Calculation section 905 can be described as follows.

Using the estimates
\tilde{ν} and \hat{ψ},
   we have now an estimate of the inlier density given by

f( [symbol] |x,\hat{ψ},\tilde{ν}).

Since, we expect outliers to be in the tails of the inlier density, we may be decided whether a sample is an outlier on whether the sample has a low p-value.

Note that by assumption, we have that all samples in
\hat{β}
   are inliers, and thus it is sufficient to focus on the p-values for the remaining data points U, i.e.

U:={1, . . . , n}\\hat{B},

under the null hypotheses that they were sampled from

f_{\hat{θ}}.:

p-valueᵢ:=P(f(Y|x,\hat{ψ},\tilde{ν})≤f( [symbol] ᵢ|xᵢ,\hat{ψ},\tilde{ν})|Y˜f(·|xᵢ,\hat{ψ},\tilde{ν})),
for i∈U.

### Outlier Decision Section

Estimation of outliers with FDR control is explained. The processes carried out by the Outlier decision section 906 can be described as follows. In situations, where we do not have any good estimate
\tilde{m}₀
   (or prior probability on m₀), we can specify
\tilde{m}₀
   such that the resulting estimate of
ν₀,
   leads to estimates of p-values that never underestimate the true p-values.

In the following, to make clear the dependence of

\tilde{ν} on \tilde{m}₀,

we may write

\tilde{ν}(\tilde{m}₀).

Analogously, we write

p-valueᵢ(\tilde{m}₀), instead of p-valueᵢ,

i.e.

p-valueᵢ(\tilde{m}₀):=P(f(Y|x,\hat{ψ},\tilde{ν}(\tilde{m}₀))≤f( [symbol] ᵢ|xᵢ,\hat{ψ},\tilde{ν}(\tilde{m}₀))|Y˜f(·|xᵢ,\hat{ψ},\tilde{ν}(\tilde{m}₀))).

A conservative estimate of the p-value for sample i, is given by

$$\overline{p - {value}_{i}} := {max}_{{\tilde{m}}_{0} ∈ \{ m , m + 1 , … , n \}} p - {value}_{i} ( {\tilde{m}}_{0} )$$

which may be calculated by the outlier decision section 906.

We declare all samples in U as outliers for which the null hypotheses is rejected using the Benjamini-Hochberg (BH) procedure to bound the expected number of false discoveries for some nominal value α, e.g. α=0.001. The nominal value α is input to the Conservative P-value Calculation section 905 (Not shown in FIG. 9). In the Conservative P-value Calculation section 905 uses the nominal value α for the BH procedure. All other samples are considered as inliers by the outlier decision section 906. If we use as p-values the upper bound

p̅-̅v̅a̅l̅u̅e̅ᵢ,

then the BH procedure will ensure that the false discovery rate (FDR) of the set of declared outliers is smaller or equal to α.

As explained above, the conservative p-value calculation section 905 may determine a conservative estimate of the p-value for each sample which is given by

$$\overline{p - {value}_{i}} := {max}_{{\tilde{m}}_{0} ∈ \{ m , m + 1 , … , n \}} p - {value}_{i} ( {\tilde{m}}_{0} )$$

to find the estimated number of inliers
\tilde{m}₀
   for which the resulting estimate of the dispersion parameter leads to the highest p-value for each sample.

### Advantageous Effect of the Forth Example Embodiment

As long as
\tilde{m}₀
   is closer the true number of inliers than the lower bound m, the estimate of dispersion parameter may be improved. Crucially, even if

\tilde{m}₀>m₀,

i.e
\tilde{m}₀
   is larger than the true number of inliers, the proposed estimator of the dispersion parameter may not be in influenced by the presence of outliers.

According to the information processing apparatus 900 of the fourth example embodiment, it is possible to get an accurate estimate of the inlier distribution, and thus enables to accurately detect outliers in the data. Accurate outlier detection is crucial for example to spot malicious activities from process log data, or to identify defective products from sensor data.

### Example of Configuration Achieved by Software

One or some of or all of the functions of the information processing apparatuses 100, 600, 700 and 900 can be realized by hardware such as an integrated circuit (IC chip) or can be alternatively realized by software.

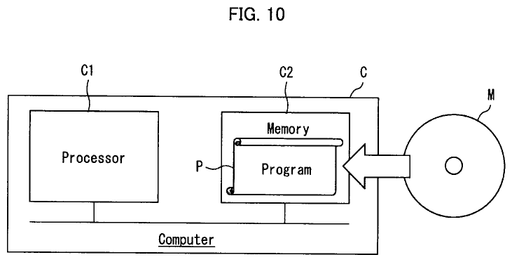

In the latter case, each of the information processing apparatuses 100, 600, 700 and 900 is realized by, for example, a computer that executes instructions of a program that is software realizing the foregoing functions. FIG. 10 illustrates an example of such a computer (hereinafter, referred to as “computer C”). The computer C includes at least one processor C1 and at least one memory C2. The memory C2 stores a program P for causing the computer C to function as any of the information processing apparatuses 100, 600, 700 and 900. In the computer C, the processor C1 reads the program P from the memory C2 and executes the program P, so that the functions of any of the information processing apparatuses 100, 600, 700 and 900 are realized.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a microcontroller, or a combination of these. The memory C2 can be, for example, a flash memory, a hard disk drive (HDD), a solid state drive (SSD), or a combination of these.

Note that the computer C can further include a random access memory (RAM) in which the program P is loaded when the program P is executed and in which various kinds of data are temporarily stored. The computer C can further include a communication interface for carrying out transmission and reception of data with other devices. The computer C can further include an input-output interface for connecting input-output devices such as a keyboard, a mouse, a display, and a printer.

The program P can be stored in a non-transitory tangible storage medium M which is readable by the computer C. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

It should be understood that the foregoing description is only illustrative of preferred embodiments of the present invention. Various alternatives and modifications can be devised by those skilled in the art without departing from the present invention. Accordingly, the present invention is intended to embrace all such alternatives, modifications, and variances that fall within the scope of the foregoing description.

### Additional Remark 1

The present invention is not limited to the foregoing example embodiments, but may be altered in various ways by a skilled person within the scope of the claims. For example, the present invention also encompasses, in its technical scope, any example embodiment derived by properly combining technical means disclosed in the foregoing example embodiments.

### Additional Remark 2

The whole or part of the example embodiments disclosed above can be described as follows. Note, however, that the present invention is not limited to the following example aspects.

### Supplementary Notes 1

Aspects of the present invention can also be expressed as follows:

(Aspect 1)

An information processing apparatus, comprising:
an input means for receiving a plurality of input samples including a plurality of responses and a plurality of covariates;
a statistic calculation means for transforming the responses into a plurality of transformed samples using a function depending on the covariates and an unbiased parameter so that a distribution of the transformed samples only depends on a dispersion parameter; and
an optimization means for maximizing the distribution of the transformed samples to determine an estimate of the dispersion parameter.

According to the above configuration, it is possible to provide a preferred technique for dispersion parameter estimation.

(Aspect 2)

The information processing apparatus according to Aspect 1, wherein the statistic calculation means calculate the transformed samples using the following formula:

zᵢ:=|yᵢ−h_{\hat{ψ}}(xᵢ)|

where zᵢ represent the transformed samples, yᵢ represent the responses,
h_{\hat{ψ}}
   represents a function on the unbiased parameter and xᵢ represent the covariates.

According to the above configuration, it is possible to provide a preferred technique for dispersion parameter estimation.

(Aspect 3)

The information processing apparatus according to Aspect 1 or 2, wherein the statistic calculation means uses an unbiased estimate
\hat{ψ}
   as the unbiased parameter
ψ

According to the above configuration, it is possible to provide a preferred technique for dispersion parameter estimation by using the unbiased estimate of the parameter.

(Aspect 4)

The information processing apparatus according to Aspect 1 or 2, wherein the statistic calculation means integrates out the unbiased parameter
ψ
   from a likelihood function

f( [symbol] ᵢ|xᵢ,ψ,ν)

using a posterior distribution

p(ψ|y,X)

According to the above configuration, it is possible to provide a preferred technique for dispersion parameter estimation by integrating out integrates out the unbiased parameter.

(Aspect 5)

The information processing apparatus according to any one of Aspects 1 to 4, wherein the optimization means determines the estimate of the dispersion parameter based on a weighted average of dispersion parameters, each of which is based on a respective estimate of the number of inliers.

According to the above configuration, it is possible to provide a preferred technique for dispersion parameter estimation.

(Aspect 6)

The information processing apparatus according to any one of Aspects 1 to 5. further comprising an output means for outputting the estimate of the dispersion parameter.

(Aspect 7)

An information processing apparatus, comprising:
an input means for receiving a plurality of input samples including a plurality of responses and a plurality of covariates;
a statistic calculation means for transforming the responses into a plurality of transformed samples using a function depending on the covariates and an unbiased parameter so that a distribution of the transformed samples only depends on a dispersion parameter;
an optimization means for maximizing the distribution of the transformed samples to determine an estimate of the dispersion parameter;
a p-value calculation means for estimating p-values with reference to the estimate of the dispersion parameter; and
an outlier decision means for determining a list of outliers with reference to the p-values.

According to the above configuration, it is possible to provide a preferred technique for dispersion parameter estimation. Also, according to the above configuration, it is possible to provide a list of outliers.

(Aspect 8)

The information processing apparatus according to Aspect 7, wherein p-value calculation means determines a conservative estimate of the p-value for each sample to find the estimated number of inliers for which the resulting estimate of the dispersion parameter leads to the highest p-value for each sample.

According to the above configuration, it is possible to provide an estimated number of inliers.

(Aspect 9)

The information processing apparatus according to Aspect 7 or 8. further comprising an output means for outputting the list of outliers.

(Aspect 10)

An information processing method, comprising:
receiving the input samples including a plurality of responses and a plurality of covariates;
transforming the responses into a plurality of transformed samples using a function depending on the covariates and an unbiased parameter so that a distribution of the transformed samples only depends on the dispersion parameter; and
maximizing the distribution of the transformed samples to determine an estimate of the dispersion parameter.

(Aspect 11)

An information processing method, comprising:
receiving a plurality of input samples including a plurality of responses and a plurality of covariates;
transforming the responses into a plurality of transformed samples using a function depending on the covariates and an unbiased parameter so that a distribution of the transformed samples only depends on the dispersion parameter;
maximizing the distribution of the transformed samples to determine an estimate of the dispersion parameter;
estimating p-values with reference to the estimate of the dispersion parameter; and
determining a list of outliers with reference to the p-values.

(Aspect 12)

A control program for causing a computer to function as a host of an information processing apparatus recited in Aspect 1, the control program being configured to cause the information processing apparatus to function as the input means, the statistic calculation means and the optimization means.

(Aspect 13)

A control program for causing a computer to function as a host of an information processing apparatus recited in Aspect 7, the control program being configured to cause the information processing apparatus to function as the input means, the statistic calculation means, the optimization means, the p-value calculation means and the outlier decision means.

(Aspect 14)

A non-transitory storage medium storing the control program recited in Aspect 12 or 13.

(Aspect 15)

An information processing apparatus comprising at least one processor, the processor
receiving a plurality of input samples including a plurality of responses and a plurality of covariates;
transforming the responses into a plurality of transformed samples using a function depending on the covariates and an unbiased parameter so that a distribution of the transformed samples only depends on a dispersion parameter; and
maximizing the distribution of the transformed samples to determine an estimate of the dispersion parameter.

(Aspect 16)

An information processing apparatus comprising at least one processor, the processor
receiving a plurality of input samples including a plurality of responses and a plurality of covariates;
transforming the responses into a plurality of transformed samples using a function depending on the covariates and an unbiased parameter so that a distribution of the transformed samples only depends on the dispersion parameter;
maximizing the distribution of the transformed samples to determine an estimate of the dispersion parameter;
estimating p-values with reference to the estimate of the dispersion parameter; and
determining a list of outliers with reference to the p-values.

### Supplementary Notes 2

Aspects of the present invention can also be expressed as follows:

(Aspect A1)

An information processing apparatus for determining the dispersion parameter
ν
   from a set of inlier samples

\hat{B} (with m=|\hat{B}|)

comprising:
a sufficient statistic calculation component which for each sample i in
\hat{B},
   transforms the response yᵢ to zᵢ, using a function which depends on the covariates, and a parameter vector
ψ,
   such that the distribution of zᵢ does only depend on
ν;
   an optimization component which find the parameter
\tilde{ν}
   which optimizes the probability of observing the transformed samples
(i.e. { [symbol] ᵢ}_{i∈\hat{B}})
   as being the m closest samples out of
\tilde{m}₀
   samples from the inlier distribution parameterized by
ν,
   where
\tilde{m}₀
   is an estimate of the number of inliers.

(Aspect A2)

The aspect A 1, where instead of using one estimate of the parameter vector
ψ,
   the method integrates over the posterior distribution of
ψ.

(Aspect A3)

The aspect A1, where instead of using one estimate
\tilde{m}₀
   for the true number of inliers
m₀,
   the method uses several possible estimates of
m₀,
   and then determines the final estimate of
ν
   using a weighted average where the weights are determined using a prior distribution
p(m₀).

(Aspect A4)

The aspect A1 which determines a conservative estimate of the p-value for each sample, finding the
\tilde{m}₀
   for which the resulting estimate of
ν
   leads to the highest p-value for each sample.

### REFERENCE SIGNS LIST

100, 600, 700, 900 Information Processing Apparatus
601, 901 Data Base
102, 603, 702, 902 Input Section
104, 605, 704, 903 Static Calculation Section
106, 607, 706, 904 Optimization Section
708, 905 P-value Calculation Section
710, 906 Outlier Decision Section
S20, S80 Information Processing Method
S22, S82 Input Step
S24, S84 Statistic Calculation Step
S26, S86 Optimization Step
S87 P-value Calculation Step
S89 Outlier Decision Step

What is claimed is:

1. An information processing apparatus, comprising at least one processor, the processor carrying out
an input process for receiving a plurality of input samples including a plurality of responses and a plurality of covariates;
a statistic calculation process for transforming the responses into a plurality of transformed samples using a function depending on the covariates and an unbiased parameter so that a distribution of the transformed samples only depends on a dispersion parameter; and
an optimization process for maximizing the distribution of the transformed samples to determine an estimate of the dispersion parameter.

2. The information processing apparatus according to claim 1, wherein the statistic calculation process includes calculating the transformed samples using the following formula: [symbol]
ᵢ:=|yᵢ−h_{\hat{ψ}}(xᵢ)|

where zi represent the transformed samples, yi represent the responses,
h_{\hat{ψ}}
represents a function on the unbiased parameter and xi represent the covariates.

3. The information processing apparatus according to claim 1, wherein the statistic calculation process includes using an unbiased estimate
\hat{ψ}
as the unbiased parameter
ψ

4. The information processing apparatus according to claim 1, wherein the statistic calculation process includes integrating out the unbiased parameter
ψ
from a likelihood function
f( [symbol] ᵢ|xᵢ,ψ,ν)
using a posterior distribution
p(ψ|y,X)

5. The information processing apparatus according to claim 1 wherein the optimization process includes determining the estimate of the dispersion parameter based on a weighted average of dispersion parameters, each of which is based on a respective estimate of the number of inliers.

6. The information processing apparatus according to claim 1, further comprising an output process for outputting the estimate of the dispersion parameter.

7. An information processing apparatus, comprising at least one processor, the processor carrying out
an input process for receiving a plurality of input samples including a plurality of responses and a plurality of covariates;
a statistic calculation process for transforming the responses into a plurality of transformed samples using a function depending on the covariates and an unbiased parameter so that a distribution of the transformed samples only depends on a dispersion parameter;
an optimization process for maximizing the distribution of the transformed samples to determine an estimate of the dispersion parameter;
a p-value calculation process for estimating p-values with reference to the estimate of the dispersion parameter; and
an outlier decision process for determining a list of outliers with reference to the p-values.

8. The information processing apparatus according to claims 7, wherein the p-value calculation process includes determining a conservative estimate of the p-value for each sample to find the estimated number of inliers for which the resulting estimate of the dispersion parameter leads to the highest p-value for each sample.

9. The information processing apparatus according to claim 7, further comprising an output process for outputting the list of outliers.

10. An information processing method, comprising:
receiving the input samples including a plurality of responses and a plurality of covariates;
transforming the responses into a plurality of transformed samples using a function depending on the covariates and an unbiased parameter so that a distribution of the transformed samples only depends on the dispersion parameter; and
maximizing the distribution of the transformed samples to determine an estimate of the dispersion parameter.

11. An information processing method according to claim 10, further comprising:
estimating p-values with reference to the estimate of the dispersion parameter; and
determining a list of outliers with reference to the p-values.

12. A non-transitory storage medium storing the control program for causing a computer to function as a host of an information processing apparatus recited in claim 1, the control program being configured to cause the information processing apparatus to function as the input means, the statistic calculation means and the optimization means.

13. A non-transitory storage medium storing the control program for causing a computer to function as a host of an information processing apparatus recited in claim 7, the control program being configured to cause the information processing apparatus to function as the input means, the statistic calculation means, the optimization means, the p-value calculation means and the outlier decision means.

14. (canceled)
